(19) United States
(12) Patent Application Publication
(10) Pub. No.: US 2008/0024691 A1
(43) Pub. Date: Jan. 31, 2008

(54) Liquid crystal display and manufacturing method thereof

(76) Inventors: Noriyuki Okabe, Chiba (JP); Tetsuya Kawamura, Mobara (JP); Masashi Sato, Mobara (JP); Kenta Kamoshida, Tokorozawa (JP)

Correspondence Address: REED SMITH LLP, Suite 1400, 3110 Fairview Park Drive, Falls Church, VA, 22042, US

(21) Appl. No.: 11/730,867

(22) Filed: Apr. 4, 2007

(30) Foreign Application Priority Data
Apr. 21, 2006 (JP) 2006-118221

(51) Int. Cl. G02F 1/1333

(52) U.S. Cl. 349/54

(57) ABSTRACT

A normal transistor CTFT connected to a data signal line DL and a pixel electrode PX and a spare transistor FTFT in a floating state are formed on a gate line GL. When an operational abnormality occurs in the normal transistor CTFT, the normal transistor CTFT is cut off from the data signal line DL and the pixel electrode PX by cutting lines CL. The spare transistor FTFT is connected to the data signal line DL and the pixel electrode PX by repair lines RL.

### CLAIM OF PRIORITY

The present application claims priority from Japanese application Ser. No. 2006-118221, filed on (Apr. 21, 2006 ), the content of which is hereby incorporated by reference into this application.

### BACKGROUND OF THE INVENTION

1. Field of the Invention

The present invention relates to a thin-film transistor liquid crystal display and a manufacturing method thereof, and deals with abnormality in the operation of a thin-film transistor.

2. Description of the Related Art

In a thin-film transistor liquid crystal display device, scan signal lines selected by scan signals and data signal lines to which data signals are applied are connected to liquid crystal pixels arranged in a matrix. The scan signal lines and the data signal lines are wired in the vertical direction and the horizontal direction of a display screen, and one or more transistors are connected to the intersecting portions of these lines.

When an operational abnormality occurs in these transistors, a bright spot defect or a black spot defect occurs depending on the relationship between the content of the abnormality and the operation mode of the liquid crystal. There are various methods for repairing these defects, but it is difficult to repair a transistor whose operation has become abnormal, and black spot repair that abandons drive operation resulting from a transistor and wires a pixel electrode to another line and a method that wires a pixel electrode to another pixel electrode to perform the same display with two pixels and make the defect inconspicuous are common.

In this manner, when an abnormality in the operation of a transistor occurs, the abnormal transistor is cut off from the pixel electrode and, at the same time, the pixel electrode that has been cut off is connected to another line or an adjacent pixel electrode to make the defect inconspicuous.

In JP-A-5-341316, connecting two transistors to one pixel and cutting off a transistor that has become abnormal is described.

In JP-A-7-104311, disposing a spare transistor for one pixel, cutting off a transistor that has become abnormal, and connecting the spare transistor is described.

When, in order to repair a defect in a display resulting from an abnormality in the operation of a thin-film transistor, the pixel connected to the operationally abnormal transistor is cut off from the operationally abnormal transistor, connected to another line, and becomes a black spot, the pixel that has become a black spot continues to display black regardless of the screen that is to be originally displayed.

In a color liquid crystal display, pixels having color filters of three or more colors light up at the same time and display white, so that if a black spot in one color occurs, that one color does not light up in the white display state and ends up appearing as a complementary color of the color that does not light up. Particularly in uses such as a liquid crystal television where the pixel size is large, even a black spot defect ends up appearing as a colored spot defect in the white display.

Further, the method of cutting off a pixel connected to an operationally abnormal transistor from the operationally abnormal transistor and connecting the pixel to an adjacent pixel is effective when displaying white, but when red, green, and blue are displayed using a color filter of a single color, a phenomenon occurs where a pixel that is not supposed to light up ends up lighting up or a pixel that is supposed to light up ends up not lighting up, so it is difficult to say that the repair is infallible.

In the method of connecting two transistors to one pixel as described in JP-A-5-341316, parasitic capacitance between the scan signal lines and the data signal lines becomes large, and the problem of signal delay occurs.

Further, in the method of disposing a spare transistor for one pixel as described in JP-A-7-104311, parasitic capacitance is added to the spare transistor in order to reduce differences in display characteristics resulting from driving by the normal transistor and driving by the spare transistor, but a connection portion for adding parasitic capacitance must be patterned beforehand, and the problem of signal delay resulting from the affects of parasitic capacitance occurs.

In this manner, even when operation of a thin-film transistor is abnormal, it is necessary to realize white color display that is uniform within the screen, single color display that is uniform within the screen, and bright display that is uniform within the screen.

### SUMMARY OF THE INVENTION

In the present invention, a spare transistor not connected to a data signal line and a pixel electrode is formed in addition to a normal transistor for driving a pixel. Then, at the stage when an abnormality has been discovered in the operation of the normal transistor for driving the pixel, this transistor is cut off from the data signal line and the pixel electrode, and the spare transistor is connected to the data signal line and the pixel electrode.

According to the present invention, in regard to a spot defect resulting from an abnormality in the operation of a thin-film transistor, the thin-film transistor whose operation is abnormal is cut off from the data signal line and the pixel electrode, and the data signal line and the pixel electrode are reconnected to the spare thin-film transistor, so that display where there are no color shifts resulting from signal delay and black spots between white display and single color display can be performed.

### BRIEF DESCRIPTION OF THE DRAWINGS

FIGS. 1A to 1C are configural diagrams of a pixel portion in a liquid crystal display pertaining to the present invention.

### DETAILED DESCRIPTION OF THE INVENTION

An embodiment of the present invention will be described below using the drawings.

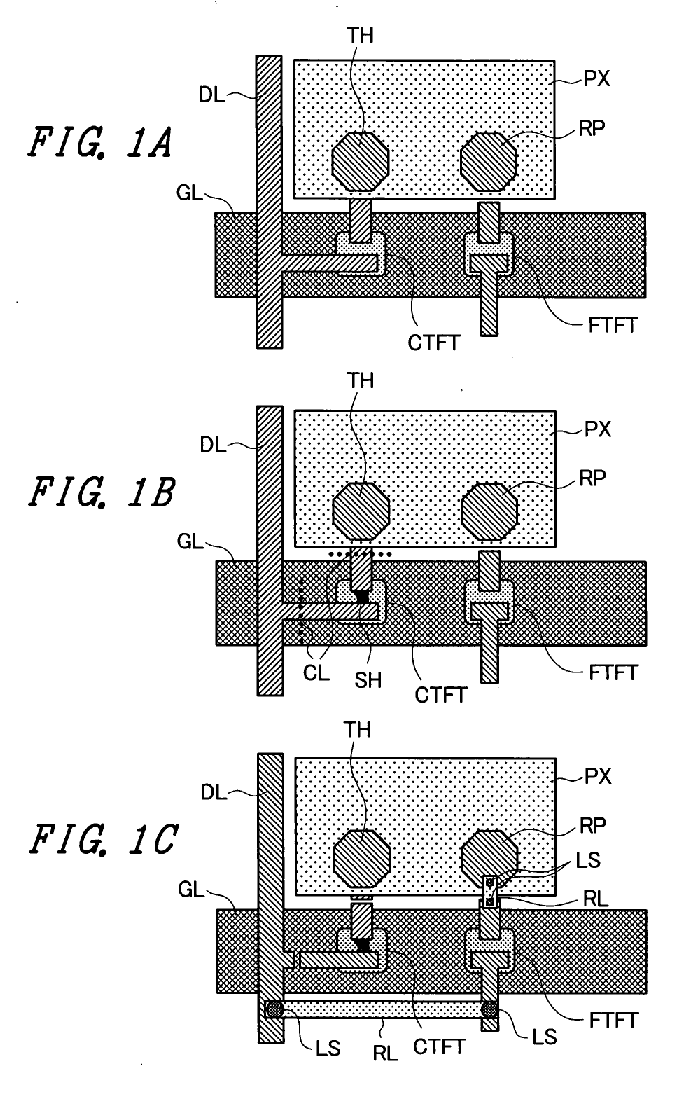

FIGS. 1A to 1C are basic configural diagrams of a pixel portion in a liquid crystal display including pixel portions arranged in a matrix. FIG. 1A is a configural diagram showing when there is no operational abnormality in a normal thin-film transistor, FIG. 1B is a configural diagram showing when an operationally abnormal transistor is being cut off, and FIG. 1C is a configural diagram showing when the operationally abnormal transistor has been cut off and a spare transistor is connected.

Turning now to FIG. 1A, a normal transistor CTFT that is connected to a data signal line DL and a pixel electrode PX and a spare transistor FTFT that is in a floating state where it is not connected to the data signal line DL and the pixel electrode PX are formed on a gate line GL. In this manner, because the spare transistor FTFT is in a floating state, it does not generate parasitic capacitance and does not affect normal operation.

It will be noted that the normal transistor CTFT and the pixel electrode PX are connected by a through hole TH. Further, a conductor region RP may also be formed on the pixel electrode PX in order to facilitate repair work.

Turning now to FIG. 1B, when an operational abnormality occurs in the normal transistor CTFT, such as when a short SH occurs between the source and drain of the normal transistor CTFT, then the operationally abnormal transistor CTFT is cut off by a cutting line CL from one or both of the data signal line DL and the pixel electrode PX.

Turning now to FIG. 1C, a repair line RL that connects the spare transistor FTFT and the data signal line DL is formed. Further, a repair line RL that connects the spare transistor FTFT and the pixel electrode PX is formed. The repair lines RL may be formed by any method as long as it is one that can locally form a conductor. For example, the repair lines RL can be formed without problem by an existing technique such as laser CVD.

Next, the spare transistor FTFT is connected to the data signal line DL and the pixel electrode PX by laser spots LS that have been heat-welded utilizing a laser or the like. In this manner, in the state where the spare transistor has been connected, the normal transistor does not generate parasitic capacitance because it is cut off and in a floating state. Consequently, the spare transistor can drive the pixel portion without delay in the same manner as normal operation.

What is claimed is:

1. A liquid crystal display including pixel portions arranged in a matrix, wherein a first transistor connected to a data signal line and a pixel electrode and a second transistor not connected to the data signal line and the pixel electrode are disposed in each of the pixel portions.

2. The liquid crystal display of claim 1, wherein a conductor region for connecting the second transistor is disposed on the pixel electrode of each of the pixel portions.

3. The liquid crystal display of claim 1, wherein the first transistor and the second transistor are disposed on a gate electrode.

4. A liquid crystal display including pixel portions arranged in a matrix, wherein a normal transistor in a floating state and a spare transistor connected to a data signal line and a pixel electrode are formed in some of the pixel portions.

5. A liquid crystal display manufacturing method comprising:
forming a normal transistor and a spare transistor in a floating state on pixel portions arranged in a matrix; and
when the normal transistor is operationally abnormal, placing the normal transistor in a floating state and connecting the spare transistor to a data signal line and a pixel electrode with a repair line.

6. The liquid crystal display manufacturing method of claim 5, wherein the normal transistor is placed in the floating state by cutting apart the normal transistor and the pixel electrode.
